(19) United States
(12) Patent Application Publication
(10) Pub. No.: US 2007/0258715 A1
(43) Pub. Date: Nov. 8, 2007

(54) Modular, Easily Configurable and Expandible Node Structure for an Optical Communications Network

(76) Inventors: Daniele Androni, Gragnano (PC) (IT); Fulvio Arecco, Monza (MI) (IT); Eugenio Iannone, Milano (IT); Giacomo Antonio Rossi, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/567,374

(22) PCT Filed: Aug. 7, 2003
(86) PCT No.: PCT/EP03/08748

§ 371 Date: Feb. 7, 2006

(51) Int. Cl. H04B 10/00

(52) U.S. Cl. 398/79

(57) ABSTRACT

A network node structure for an optical communications network has a housing having a plurality of slots, and a plurality of cards inserted in the slots. The plurality of cards includes at least one first card having an optical input for receiving an input WDM optical signal from an optical line of the network, a first optical device for extracting at least one component optical signal at a wavelength from the input WDM optical signal and at least one optical output making available the at least one component optical signal. At least one second card is provided, distinct from the first card, having at least one socket mechanically and electrically adapted to receive one of a plurality of interchangeable electro-optical components. Each electro-optical component has an optical input adapted to receive an input optical signal at a prescribed operating wavelength, an optical-to-electrical conversion unit for converting the received optical signal into a corresponding converted electrical signal, an electrical output making available the converted electrical signal, and an electrical input adapted to receive an input electrical signal, an electrical-to-optical conversion unit for converting the received electrical signal into a corresponding optical signal at the operating wavelength, an optical output making available the converted optical signal.

The present invention relates in general to communications networks, and more particularly to optical communications networks. More specifically, the invention relates to a node structure of an optical communications network, particularly a node structure of a wavelength division multiplexing optical communications network.

The technique of multiplexing different optical signals at different wavelengths, or Wavelength Division Multiplexing (shortly, WDM), is widely used in optical communications.

In WDM it is possible to distinguish the Coarse WDM (CWDM) and the Dense WDM (DWDM) techniques, that mainly differ from each other for the spacing between the adjacent optical communication channels (hereinafter, optical channels) and the optical wavelength band exploited. Typically, a specific central wavelength is assigned to each optical channel; in the DWDM technique, the central wavelengths of two adjacent channels differ for example of about 1.6 or 0.8 nanometers (corresponding to 200 GHz or 100 GHz in the ITU G694.1 grid), while in the CWDM technique the spacing between (the central wavelengths of) adjacent channels is 20 nm (compliant to the ITU G694.2 grid).

Optical amplification of the signals, possible in DWDM systems, allows having long network hauls; however, the optical bandwidth covered by the CWDM channels (normally, only eight channels are exploited, spanning wavelengths from 1470 nm to 1610 nm) makes the use of optical amplifiers practically impossible. Consequently, either the length of the links is to be kept relatively short, or electrical regeneration of the signals transported through the CWDM channels may be necessary. Nonetheless, there are applications in which long-haul communications networks are not essential: this is for example the case of metropolitan areas, where the CWDM technique is preferable, despite the limited number of optical channels, for its lower cost and its higher tolerance to variations of parameters, such as the temperature, which permits the implementation of cheap optical filters for multiplexing/de-multiplexing the different channels.

Typically, an optical communications network includes a plurality of nodes; each network node corresponds to a system in which one or more of several different operations on the optical signals transported through the communications network are executed. Examples of these operations are regeneration of the signals and extraction/injection (add/drop) of one or more of the optical signals transported through the WDM channels for local exploitation.

In a CWDM optical communications network the number of customers, the distances between adjacent nodes, the transmitted/received optical powers need not be defined in advance; thus, the communications network can be easily re-configured.

Nevertheless, when electrical regeneration is required, the different optical signals composing the CWDM signal (intended as the ensemble of the optical signals at different wavelengths that are transported through the CWDM channels) must be preliminary converted into electrical signals. In addition to the necessity of converting/re-converting signals from the optical to the electrical and then back to the optical domain, an important disadvantage of the electrical regeneration is the necessity of knowing the bit rate and the frequency of the incoming signals, i.e., the absence of transparency in the operations to be performed on the incoming signals with respect of the characteristics of the signals themselves.

Recently, electronic devices for the electrical regeneration of electric signals have been commercialized, which comply to the most common communication protocols adopted in CWDM communication systems; substantially, these electronic devices are Clock Data Recovery (CDR) circuits, capable of recognizing the bit rate and the frequency of the incoming signals, and adapting their operation to these parameters. Remarkably, commercially available electronic CDRs are less bulky and cheaper than optical amplifiers.

In US 2002/0186430 A1, a network node for use in a WDM communications network is disclosed, comprising a first network interface unit, for de-multiplexing an incoming WDM optical signal and for converting the incoming WDM optical signal into a plurality of electrical channels signals; a regeneration unit for regenerating the electrical channels signals; a second network interface unit, for converting and multiplexing the electrical channels signals into an outgoing WDM optical signal; and a secondary interface unit for converting at least one of the electrical channel signals into an optical signal and for extracting the optical signal at the network node. The first or the second network interface units comprise an electrical switching unit to facilitate that any electrical channels signal can selectively be converted and extracted via the secondary interface unit or converted and multiplexed into the outgoing WDM optical signal via the second network interface unit. A redundant electrical switching unit is incorporated in the other network interface unit for failure protection.

The Applicant has observed that the network node structure disclosed in that document is hardly configurable, and therefore variable contingent needs are difficult to be satisfied.

Additionally, the Applicant observes that the network node structure disclosed in that document is vulnerable to failures in the components thereof.

The Applicant observes that the possibility of easily configuring a communications network node, without incurring substantial costs, both before and after the node has been put into operation in the network, depending on the needs of the network and of the possible customers, would be very important in a communications network.

Furthermore, the Applicant observes that the possibility of repairing a node failure by simply substituting only the components thereof that caused the failure, maintaining the functionality of the communications network, would be a great advantage.

In fact, these possibilities would greatly increase the flexibility and the reliability of the communications network. In particular, the possibility of easily changing the configuration of the network node, that can be a very complex system, and thus changing the node functionalities, is highly desirable, because the costs for setting up and maintaining the communications network would be reduced.

In view of the state of the art outlined in the foregoing, it has been an object of the present invention to overcome the above-mentioned drawbacks. In particular, it has been an object of the present invention to provide a communications network node structure that ensures flexibility, easy re-configurability (also when installed and in use in the communications network) and reliability of the network node.

In order to achieve this object, according to an aspect of the present invention, a network node structure for a WDM optical communications network as set out in the claim 1 is proposed.

Summarizing, the network node structure comprises a housing having a plurality of slots, and a plurality of cards inserted in the slots.

Said plurality of cards includes at least one first card having an optical input for receiving an input WDM optical signal from an optical line of the network, a first optical device for extracting at least one component optical signal at a wavelength from the input WDM optical signal and at least one optical output making available the at least one component optical signal.

At least one second card is additionally provided, separate from the first card, having at least one socket mechanically and electrically adapted to receiving one of a plurality of interchangeable electro-optical components.

Each component has an optical input adapted to receiving an input optical signal at a prescribed operating wavelength, an optical-to-electrical conversion unit for converting the received optical signal into a corresponding converted electrical signal, an electrical output making available the converted electrical signal, and an electrical input adapted to receiving an input electrical signal, an electrical-to-optical conversion unit for converting the received electrical signal into a corresponding optical signal at the operating wavelength, an optical output making available the converted optical signal.

A selected electro-optical component of said plurality of components is plugged into the socket and has an operating wavelength corresponding to the wavelength of the extracted component optical signal.

An electronic circuitry is provided on the second card, in bi-directional communication relationship with said at least one socket, for treating the converted electrical signal provided by said selected electro-optical component.

At least one first optical waveguide connects the at least one optical output of the first card to the optical input of the selected electro-optical component, for feeding to the optical input of the electro-optical component the extracted component optical signal.

In other words, the device for extracting the component optical signal from the input WDM optical signal, and the components for converting the extracted optical signal into an electrical signal and for treating the converted signal are carried by distinct cards.

The proposed network node structure has multiple levels of configurability; in particular, two levels of configurability exist: one level of configurability is ensured by the provision of cards, such as the second card, that can be variably equipped with components, and thus configured so as to perform different functions; another level of configurability derives from the possibility of exploiting different numbers and types of cards, depending on the needs, for example more than one card like the first card, and/or more than one card like the second card.

Thanks to this multi-level configurability, the flexibility of the node structure is significantly increased.

In an embodiment of the present invention, a second optical device is further provided, having at least two optical inputs, each one adapted to receiving a respective input optical signal comprising at least one component optical signal of an output WDM optical signal made available at an optical output of the second optical device to the optical line of the network; the second optical device combines the input optical signals into the output WDM optical signal.

At least one second optical waveguide is connected between one of the at least two optical inputs of the second optical device and the optical output of the selected electro-optical component, for delivering to the second optical device the component optical signal generated by the electro-optical conversion of the input electrical signal operated by the selected electro-optical component.

The input electrical signal may be the converted electrical signal treated by the electronic circuitry, or it may correspond to a client signal of a local client of the network node.

In an embodiment of the invention, the first optical device comprises an optical de-multiplexer for de-multiplexing the input WDM optical signal into a plurality of component optical signals, and the at least one optical output of the first card comprises a plurality of optical outputs each one making available one of the plurality of component optical signals; the second optical device comprises a multiplexer for multiplexing the component optical signals into the output WDM optical signal, and the at least two optical inputs of the second optical device comprises a plurality of optical inputs, each one being adapted to receiving a respective component optical signal.

In an embodiment of the invention, the second optical device is provided on the first card.

In an alternative embodiment, the second optical device is provided on a third card distinct from the first and second cards.

The optical line of the network may include a first optical line coupled to the optical input of the first card and a second optical line coupled to the optical output of the second optical device.

In a preferred embodiment of the invention, the electronic circuitry comprises circuits adapted to regenerating the converted electrical signal. In particular, the electronic circuits are adapted to performing at least 2R signal regeneration, and, preferably, 3R signal regeneration.

Preferably, the interchangeable electro-optical components are hot pluggable/unpluggable into/from the at least one socket of the second card. Expediently, the interchangeable electro-optical components are electro-optical transceivers complying with the MultiSource Agreement (MSA), particularly Small Form Factor Pluggable (SFP) or 10 Gigabit Small. Form Factor Pluggable (XFP) transceivers.

Preferably, the second card has at least a second socket, a selected second electro-optical component of said plurality of components being plugged into the second socket and receiving/transmitting electrical signals from/to the selected electro-optical component plugged in the first socket, an optical link being further provided between the second electro-optical component and a client of the network node.

The second electro-optical component may have an operating optical wavelength corresponding to that of a selected one of the component optical signals, or it may have an operating optical wavelength different from those of the component optical signals.

The at least one second card may further include a configurable electronic switch for routing the converted electrical signals received from the at least one socket towards the electronic circuitry and for routing the converted electrical signals treated by the electronic circuitry towards the at least one socket.

A control unit may be provided in the second card, for controlling the configurable electronic switch.

Preferably, the second card comprises an electrical connections arrangement between the control unit and the socket, and the control unit is capable of detecting the presence of an electro-optical component in the socket and to automatically configure the electronic switch according to one of a number of predetermined switch configuration patterns.

The electronic circuitry is preferably capable of monitoring characteristic parameters of the converted electrical signal so as to assess a level of communication performances; the characteristic parameters may be communicated to the control unit.

The electronic circuitry of the at least one second card further includes an electrical multiplexing/de-multiplexing electronic component, adapted to receive two or more converted electrical signals at a first bit rate, coming from corresponding sockets, to multiplex the two or more converted electrical signals into an aggregated electrical signal at a second bit rate higher than the first bit rate, to be provided to a corresponding socket, and, dually, adapted to receive an electrical signal at the second bit rate and to de-multiplex it into two or more electrical signals at the first bit rate.

According to another aspect of the present invention, an optical communications network, particularly for WDM optical communications is provided, comprising at least one network node; the network node has a structure according to the first aspect of the invention.

Further features and the advantages of the present invention will be made clear by the following description of an embodiment thereof, provided purely by way of non-limitative example, description that will be conducted making reference to the attached drawings, wherein:

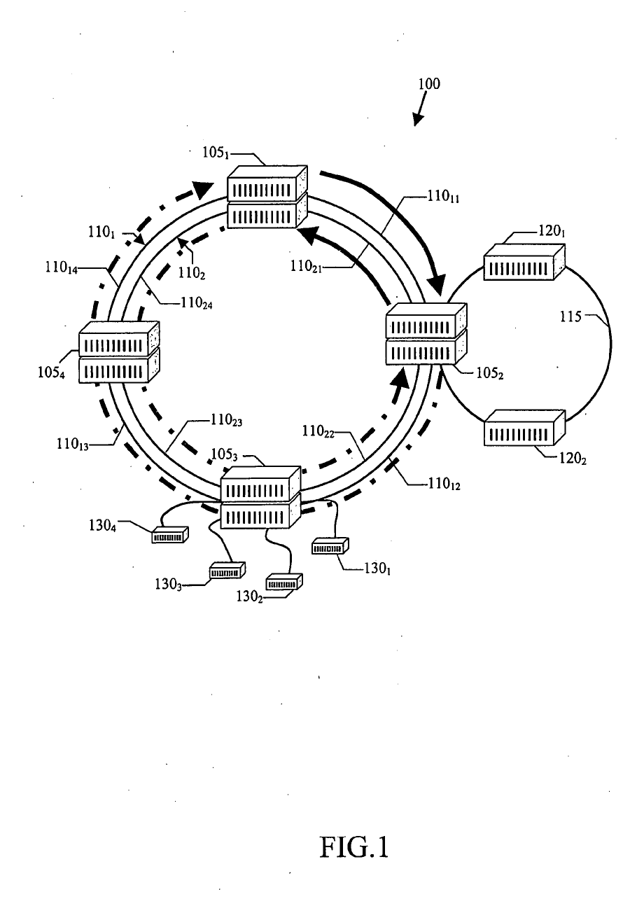

FIG. 1 schematically shows an optical communications network having a two-fiber ring topology, in which the present invention is applicable;

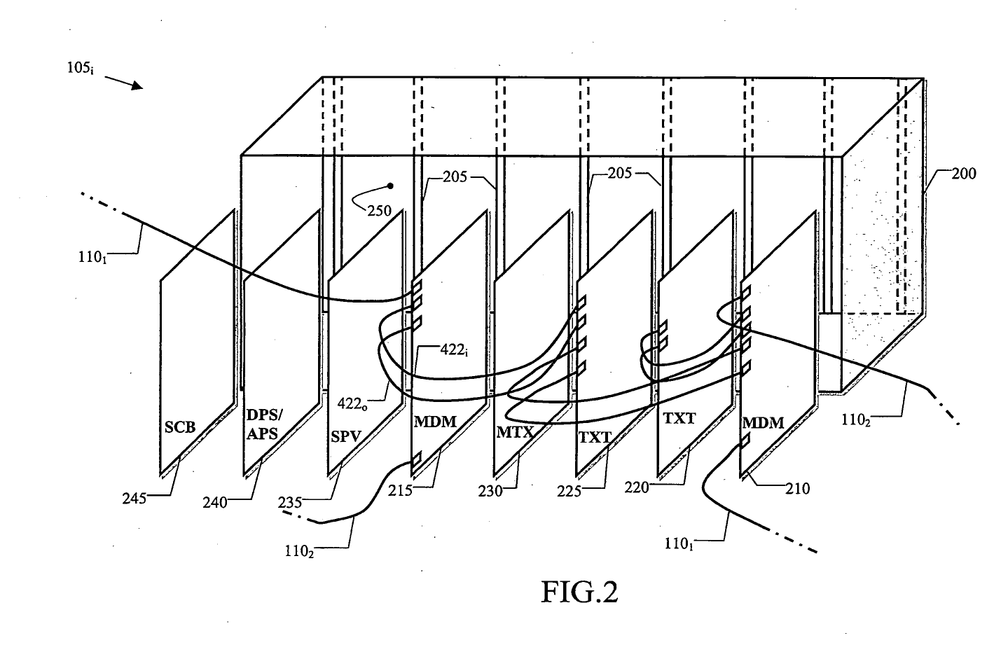

FIG. 2 illustrates in greater detail the structure of one node of the network of FIG. 1, in an embodiment of the present invention;

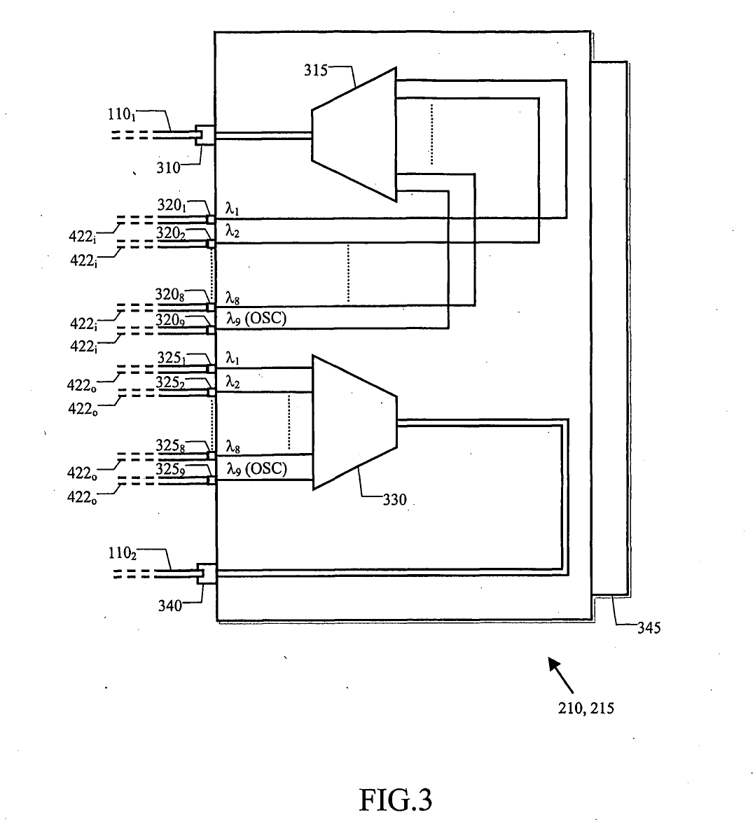

FIG. 3 is a schematic illustration of a first type of card adapted to be used in the network node of FIG. 2;

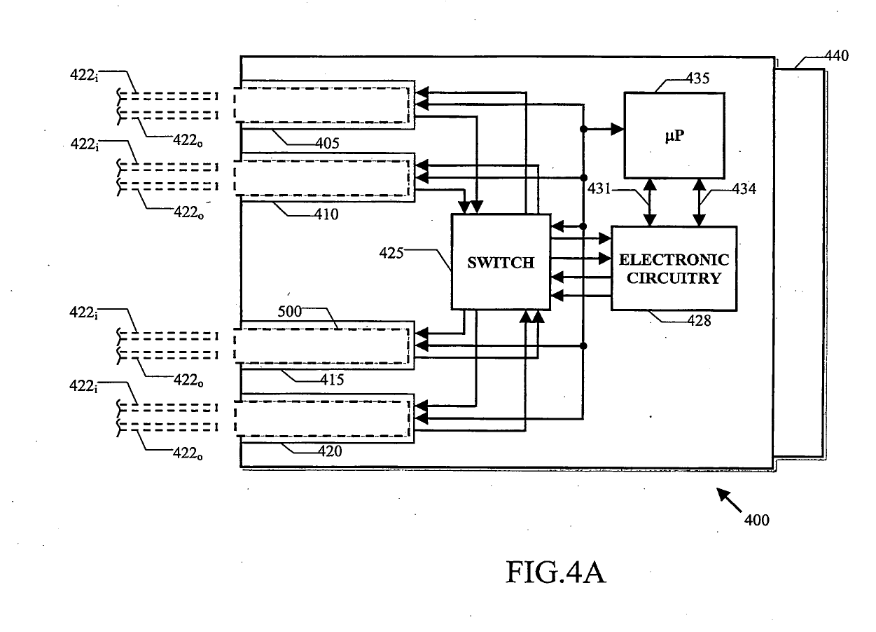

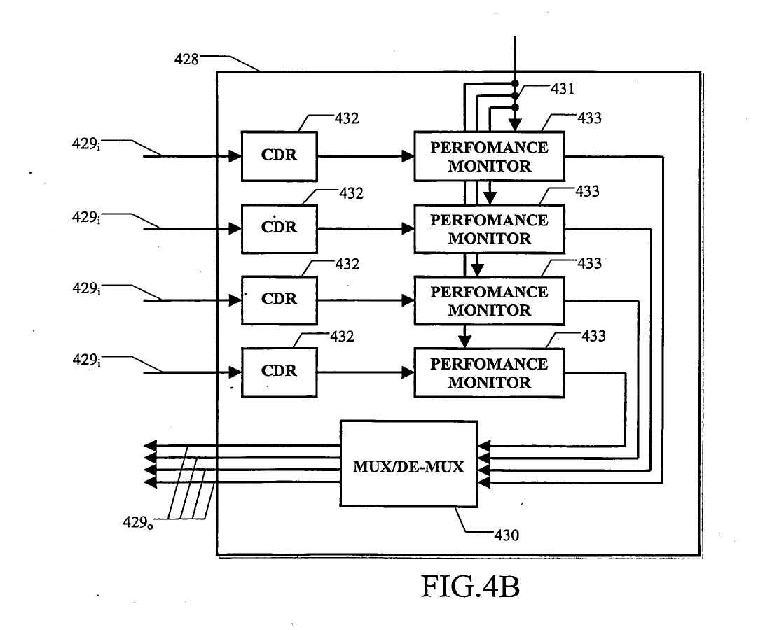

FIG. 4A is a schematic illustration of a second type of card adapted to be used in the network node of FIG. 2;

FIG. 4B illustrates a functional scheme of an electronic circuitry 428 equipping the card of FIG. 4A;

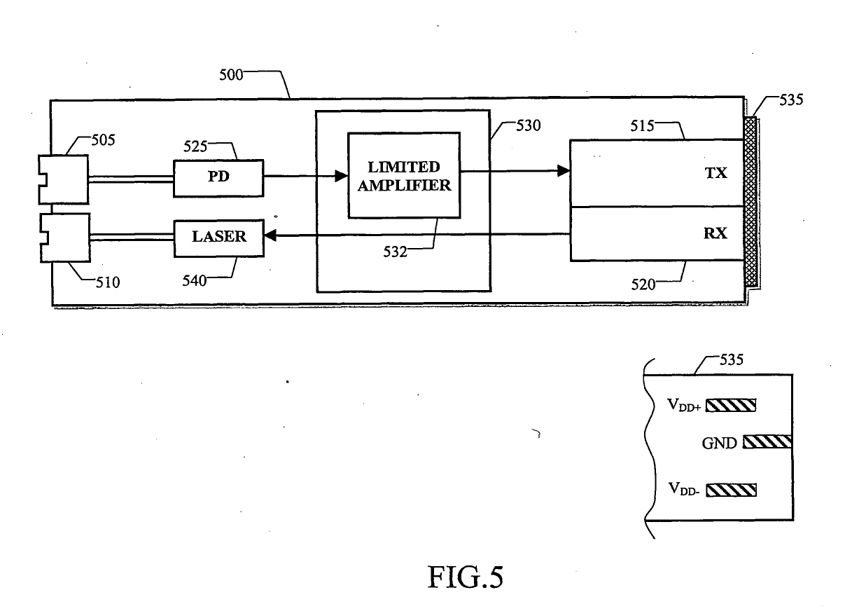

FIG. 5 is a functional scheme of an electro-optical transceiver pluggable into the card of FIG. 4A;

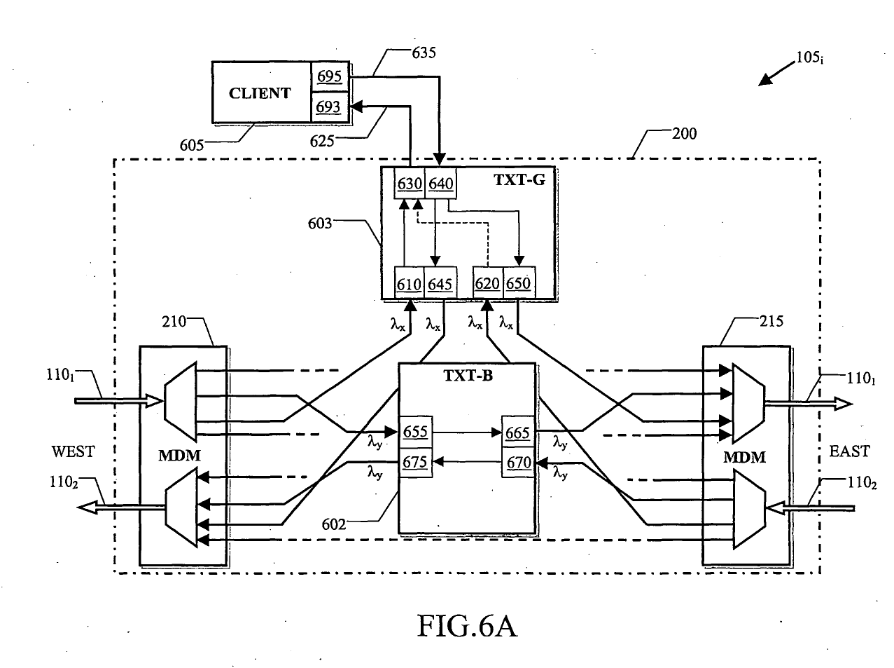

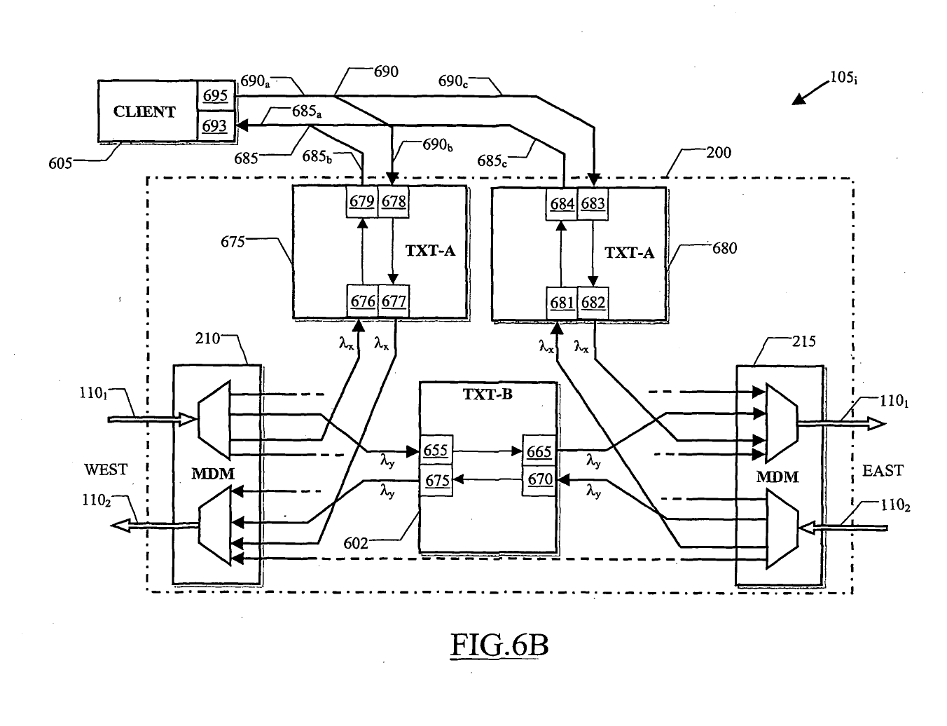

FIG. 6A is a schematic block diagram of a node of the network of FIG. 1 according to an embodiment of the present invention, particularly a node configured to perform signal regeneration and add/drop of a CWDM channel for local exploitation;

FIG. 6B is a schematic block diagram of a node of the network of FIG. 1 adapted to performing the same operations as the node of FIG. 6A, but realized according to an alternative embodiment of the present invention; and

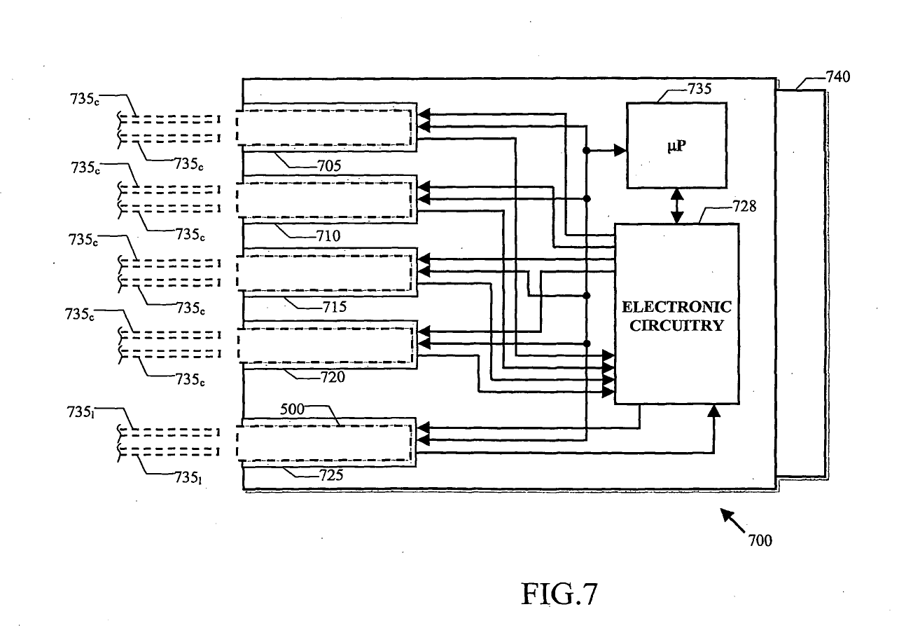

FIG. 7 is a schematic illustration of a third type of card adapted to be used in the network node of FIG. 2.

With reference to FIG. 1, an optical communications network 100 is schematically shown. In particular, and by way of non-limitative example only, the optical communications network 100 has a two-fiber (shortly, 2F) ring topology.

The optical communications network 100 is intended to support WDM optical communications and, more particularly, CWDM communications. Typically, a CWDM communications system exploits eight CWDM channels, each CWDM channel supporting communications at specific bit rates, for example at bit rates equal to or higher than 622 Mb/s. Each one of the eight CWDM channels is associated with a specific wavelength (channel central wavelength) λⱼ, with j=1, . . . , 8, respectively. In particular, the wavelengths associated with the CWDM channels can be compliant to the ITU-T Grid (G.694.2).

Preferably, an Optical Service Channel (shortly, OSC) for a service optical signal (hereinafter referred to as OSC signal) is also provided, associated with a specific central wavelength λ₉, located outside the band covered by the eight CWDM channels. For ease of description, in the following the CWDM signal will be intended as made up of the optical signals transported through the eight CWDM channels plus the OSC signal.

The network 100 has, in the shown example, four nodes 105₁, 105₂, 105₃, 105₄; two optical fiber cables (110₁₁, 110₂₁), (110₁₂, 110₂₂), (110₁₃, 110₂₃), (110₁₄, 110₂₄) connect consecutive nodes in the network, forming two communication paths (lines) 110₁, 110₂ of the network 100. Each line 110₁, 110₂ carries the CWDM signal, and the data traffic travels clockwise along the line 110₁ and anti-clockwise along the line 110₂.

The CWDM signal travels between any two of the nodes 105₁, 105₂, 105₃, 105₄ clockwise and anti-clockwise, for example, the nodes 105₁ and 105₂, a normal or working communication path between the two nodes is defined as the communication path covered by the signals traveling from the node 105₁ to the node 105₂ along the line 110₁ (clockwise), and from the node 105₂ to the node 105₁ along the line 110₂ (anti-clockwise): the signals traveling through the working communication path are referred to as working signals. This kind of network topology is commonly defined bi-directional, and each network node 105₁, 105₂, 105₃, 105₄ has two bi-directional line interfaces, hereinafter also referred to as west line interface and east line interface.

At each node 105₁, 105₂, 105₃, 105₄ one or more of a plurality of operations on the signals transported through the CWDM channels can be performed; in particular, the operations performed on the signals include signal regeneration, particularly 2R or 3R, add/drop operations of one or more of the different signals composing the CWDM signal (and, possibly, multiplexing/de-multiplexing of two or more signals at low bit rate compared to the bit rate of the signal transported through a CWDM channel, communications performance monitoring.

More specifically, the operation of 3R regeneration of one of the signals composing the CWDM signal includes: de-multiplexing the CWDM signal to separate the different component optical signals; converting a selected component optical signal to be regenerated into an electrical signal; resizing, reshaping and retiming the resulting electrical signal by means of electronic circuits; re-converting the regenerated electrical signal into an optical signal in a prescribed wavelength band; multiplexing the regenerated optical signal with the other component optical signals and then re-injecting the obtained CWDM signal into the traffic of the lines 110₁, 110₂. Optionally, a simpler 2R regeneration operation can be implemented, differing from the 3R regeneration for the fact that no retiming of the electrical signal is performed.

The add/drop operations of the CWDM component signals include extracting (dropping) from, and, respectively, injecting (adding) into, the traffic of the lines of one or more signals transported through the CWDM channels, for their use locally to the node. In greater detail, these operations involve de-multiplexing the CWDM signal to separate the different component optical signals; extracting the desired component signal for local use; multiplexing the other CWDM component signals with a locally-supplied optical signal, and re-injecting the CWDM signal into the traffic.

The operation of multiplexing two or more signals with low bit rate consists in the aggregation of these signals, performed by electronic circuits, into a signal at a higher bit rate, intended to be transported through a CWDM channel; in case the low bit rate signals are optical signals, a preliminary conversion thereof into corresponding electrical signals needs to be carried out. The aggregated electrical signal, thus obtained, is then converted into an optical signal, which is then injected (by means of an add operation) into the traffic of the lines 110₁, 110₂. The de-multiplexing operation is the opposite operation, performed on an optical signal at high bit rate, particularly one of the CWDM component signals, for extracting therefrom two or more low bit rate signals.

The performance monitoring of a signal is an operation that allows revealing quantities suitable for evaluating the performance of the communications system, such as detecting the presence/absence of the signal, detecting the signal integrity, estimating the Bit Error Rate (in jargon, BER) and the like.

A generic node 105₁, 105₂, 105₃, 105₄ of the network, such as the nodes 105₁ and 105₄ in the shown example, can be configured to operate only the 3R regeneration and the performance monitoring of the signals; in this case, the node is referred to as a pass-through node; alternatively, the network node can be connected to clients, i.e., users of the optical communications network 100, as in the case of the nodes 105₂ and 105₃; the node shall in this case have at least one client interface for interfacing the clients.

Particularly, in the shown example, the node 105₂ is assumed to be connected to an optical communications sub-network 115, having a ring topology similar to that of the network 100, including two sub-network nodes 120₁, 120₂. The sub-network 115 exploits one or more of the CWDM channels, the corresponding optical signals being dropped from (added to) the traffic of the lines 110₁, 110₂ by the network node 105₂.

The node 105₃ is instead assumed to be connected to four clients 130₁, 130₂, 130₃ and 130₄, and has corresponding client interfaces. The node 105₃ performs add/drop operations on the CWDM signal, whereby each client 130₁, 130₂, 130₃, 130₄ has, for example, associated therewith a corresponding CWDM channel; the add/drop operation is a type of line-to-client operation. Alternatively, as an example of another line-to-client operation, if the clients 130₁, 130₂, 130₃ and 130₄ communicate at a lower bit rate compared to the communication bit rate of the CWDM channels, the higher bit rate signals transported through the CWDM channels can be de-multiplexed; for example, one of the signals transported through the CWDM channels is de-multiplexed to extract four low bit rate signals, each one provided to the corresponding client 130₁, 130₂, 130₃, 130₄.

For executing the add/drop operation, the nodes 105₂ and 105₃ have to optically de-multiplex the received CWDM signal into the plurality of component optical signals, each one centered at a respective wavelength λⱼ (j=1, . . . , 8) that is associated with the corresponding CWDM channel; the optical signal centered at the desired wavelength λₓ needs to be selected for dropping. For the purposes of the present description, a component optical signal forming the CWDM signal, i.e., an optical signal centered at a wavelength corresponding to the central wavelength of any one of the CWDM channels, is referred to as a colored optical signal. Before forwarding the colored optical signal to the client or clients 130₁-130₄ or to the sub-network 115, the colored optical signal can be converted into an electrical signal, 3R regenerated and re-converted into a regenerated colored optical signal centered at the same wavelength λₓ. When a colored signal is extracted by the CWDM signal for being provided to a client (such as in the case of the node 105₃), the regenerated electrical signal can be re-converted into a regenerated optical signal centered at a different, more convenient wavelength (for example, a wavelength equal to about 850 nm, 1310 nm, or 1550 nm); for the purposes of the present description, an optical signal centered at a wavelength which is different from the central wavelengths of the CWDM channels is referred to as a gray optical signal. In an alternative embodiment, the regenerated electrical signal can be directly provided to the client through an electrical connection between the node 105₃ and the client.

A scheme of operation protection (protection scheme, for simplicity) is also implemented in the communications network 100. In detail, considering again the two nodes 105₁ and 105₂, in addition to the direct, working communication path, a redundant or protection communication path is defined for the traffic traveling between the two nodes 105₁, and 105₂; the protection path comprises the optical links (110₁₂, 110₁₃, 110₁₄) and (110₂₂, 110₂₃, 110₂₄) that cross the nodes 105₃ and 105₄, i.e., the arcs of the lines 110₁, 110₂ complementary to the arcs defining the working path. In case of a failure on the direct connection path between the two nodes 105₁ and 105₂ (working communication path), the protection communication path can be exploited for ensuring continuity of the network operation; the signals traveling along the protection path are referred to as protection signals.

Each network node receives the CWDM signal both from the working path, at one of the two line interfaces thereof (west or east line interface), and from the protection path, at the other line interface (east or west). Moreover, each node re-injects the CWDM signal both into the working path (working CWDM signal) and into the protection path (protection CWDM signal). In this way, for each CWDM channel the working signal travels along the working path and, at the same time, the corresponding protection signal travels along the protection path.

The service optical signal transported through the OSC carries information provided by, or for, network supervision units, that can be local to a node 105₁, 105₂, 105₃, 105₄, for supervising the node operation, or remote (i.e., a unit supervising the operation of the whole network 100). The local and remote network supervision units monitor the network status, particularly in order to determine when the protection scheme is to be actuated. In case of failure on the working communication path, a protection mechanism switches the communications onto the protection communication path; when the failure on the working path is repaired, a restoration process can be actuated to switch the communications back to the working path.

The protection mechanism needs to be flexible and the supervision units need to monitor several parameters, so as to adapt the restoration process to the needs of the clients. These parameters include for example parameters indicating which optical links and which node components implement the working and the protection paths, or whether the working path has to be automatically restored, when the signals comply with required characteristics, or in which nodes the working path has to be turned off.

It is observed that, although in the exemplary embodiment of FIG. 1 a network with a 2F ring topology is shown, networks with a one-fiber (1F) ring topology are also possible: in this case, the optical communications network has only one optical path. The nodes of a 1F ring network feature two unidirectional line interfaces, and no protection scheme of the CWDM channels is available.

It is also observed that although in the exemplary embodiment shown in FIG. 1 a bi-directional 2F ring network topology is shown, a 2F ring topology can in general be uni-directional or bi-directional. In a uni-directional 2F ring network topology, each line supports one direction of traffic, as in the bi-directional topology, but one of the two lines is redundant and used only for protection purposes. Supposing for a moment that the network of FIG. 1 is uni-directional instead of bi-directional, the signals would normally travel, for example, from the node 105₁ to the node 105₂ through the arc 110₁₁ of the line 110₁ and from the node 105₂ to the node 105₁ through the complementary arc (110₁₂, 110₁₃, 110₁₄) of the line 110₁ (working path). In case of failure of the working path connecting two nodes, the protection scheme would be actuated: the direction of the traffic would be switched, so that the traffic travels over the two complementary arcs 110₂₁ and (110₂₂, 110₂₃, 110₂₄) of the other line, in the present example the line 110₂.

It is observed that the ring topology shown in FIG. 1 is merely exemplary and not at all limitative. The optical communications network 100 may also have a linear topology, such as a point-to-point topology or a bus topology. In particular, a linear topology is implemented by means of pairs of optical fiber cables, which connect intermediate and terminal nodes. The CWDM signal and the OSC signal travel between two nodes in the two directions, respectively defined west-to-east and east-to-west. The terminal nodes feature only one bi-directional line interface, west or east, while each intermediate node features two (east and west) bi-directional line interfaces.

In the point-to-point network topology, the intermediate network nodes have only signal regeneration (and, possibly, performance monitoring) functionalities, while the terminal nodes additionally manage line-to-client and client-to-line interfacing functionalities, not present in the intermediate nodes. Differently, in the bus network topology the add/drop operations on the CWDM signal are managed also by the intermediate nodes, which, similarly to the terminal nodes, may have client interfaces.

It is worth observing that a network having a 2F ring topology, such as the network 100, can be viewed as a network with a bus topology, folded to form a ring and in which the two terminal nodes coincide with each other.

Linear network topologies can be exploited to connect a network node 105ᵢ (i=1, . . . , 4) with the respective clients. For example, in FIG. 1 the connections from the network node 105₃ to each client 130₁, 130₂, 130₃, 130₄ is a particular type of point-to-point connection, without intermediate nodes, because the connections are supposed short and no signal regeneration is needed. Alternatively, the four clients 130₁, 130₂, 130₃, 130₄ can be connected to the node 105₃ by means of a further sub-network with a bus topology, each node of the bus sub-network being connected to one or more of the clients 130₁, 130₂, 130₃, 130₄.

It can be appreciated that the specific structure of a network node greatly depends on contingent needs, i.e., on the operations that the node is intended to perform. For example, in order to carry out the 3R regeneration of a given component optical signal of the CWDM signal, the CWDM signal needs to be decomposed (de-multiplexed) into the component optical signals, the desired optical signals needs to be converted into an electrical signal, and the communication bit rate needs to be recognized. A client of the network, connected to a given mode, may have the necessity of extracting from the CWDM signal traveling on the network 100 a signal centered at a wavelength λₓ, arbitrarily chosen among the different CWDM channel central wavelengths; the number of the clients connected to a node can vary in time, for example, the number of clients can increase.

Generally speaking, if the network node has a rigid and not re-configurable structure, adapting the network to the changes in the contingent necessities might be hard, not to say impossible. Every change in the needs of clients or of a sub-network of the network would pose serious problems, especially in terms of costs; for example, the only feasible solution it might be the complete replacement of a node with another of different structure.

For the above reasons, according to an embodiment of the present invention, the network node has a modular structure allowing easy re-configuration of the node, as will be described in the following.

Considering FIG. 2, the structure of a generic node 105ᵢ of the optical communications network 100, according to an embodiment of the present invention, is illustrated schematically but in greater detail. The node 105ᵢ comprises a box shaped casing (in jargon, a shelf) 200, having a plurality of housings (in jargon, slots) 205 for cards 210-245.

The slots 205 of the shelf 200 are designed to provide mechanical and electrical connection capabilities between the cards 210-245, that can be inserted therein, and an electrical connection backplane 250 of the shelf 200. The electrical connection backplane 250 may additionally host system control units for managing and controlling the operation of the node 105ᵢ.

Each card 210-245 has one or more specific functionalities, in particular cards 210-230. are provided that are equipped with components suitable for processing the component optical signals of the CWDM signal.

Specifically, in the exemplary embodiment of the invention shown in the drawing, the node 105ᵢ includes one or more cards (two cards 210, 215 in the shown example, hereinafter, concisely, MDM cards) carrying optical multiplexers/de-multiplexers, particularly of passive type; each one of the MDM cards 210, 215 forms a line interface of the network node. It is observed that in an alternative embodiment of the invention, only one MDM card can be provided, or one of the MDM cards may carry a de-multiplexer, while the other MDM card may carry a multiplexer.

One or more multipurpose cards can be provided (in the shown example, two cards 220, 225, hereinafter referred to as TXT cards) that are capable of acting as transponders from the line to a possible client, and/or from the line to the line.

The network node may also include one or more cards (one card 230 in the shown example, hereinafter MXT card) with functions of electrical multiplexer of multiple signals at low bit rate.

Additionally, the node 105ᵢ includes one or more cards (one card 235 in the shown example, hereinafter SPV card) with functions of shelf supervisor unit, managing information on the node 105ᵢ, preferably adapted to interact with a local supervision unit (e.g., a personal computer connectable to the shelf supervisor unit of the network node) and capable of communicating with a network management unit. One or more cards (one card 240 in the shown example, hereinafter APS/DPS card) are further provided with functions of AC and DC power supplies for the shelf.

In an embodiment of the present invention, a network node may include more than one shelf 200, depending on the complexity of the operations to be executed and on the specific needs of the node 105ᵢ, for example, depending on the number of clients connected to the node. For this reason, the shelf 200 preferably includes one card 245 (hereinafter referred to as SCB card) with functions of shelf common board, i.e., a printed circuit board with electrical contacts, buses and connectors for connecting together two shelves 200.

As it will be described in the following, the cards 210-235 have optical and/or electrical inputs and outputs, preferably accessible from a front side (possibly, a front panel) of the shelf 200 through suitable optical and/or electrical connectors.

It can already be appreciated that the above described network node structure is easily configurable, so as to be adaptable to the needs of each node 105ᵢ of the network. The functionality of the node 105ᵢ can be enriched by adding further cards in the shelf 200, or even a further shelf. At the same time, a breakdown internal to the node 105ᵢ can be easily repaired by substituting a damaged card.

FIG. 3 schematically shows the structure of the MDM card 210, in an embodiment of the present invention (the MDM card 215 is assumed to have an identical structure). The MDM card 210 has an optical input 310, with a suitable connector for connecting an optical fiber cable of the network. A passive optical de-multiplexer 315 is arranged to receive a composite optical signal, made up of the CWDM optical signal and the OSC signal, inputted through the optical input 310, and to de-multiplex the composite optical signal into the component signals; these component signals, comprising the eight optical signals composing the CWDM signal and the OSC signal, are then routed towards a corresponding one of a plurality of (nine) optical outputs 320₁-320₉, each provided with a respective connector for an optical fiber cable.

Additionally, in the shown embodiment of the invention, the MDM card 210 has optical inputs 325₁-325₉, each with a suitable connector for an optical fiber cable, for receiving the eight optical signals transported by the CWDM channels and the OSC signal. A passive optical multiplexer 330 is arranged to receive these nine optical signals, and to multiplex them into the CWDM signal; the CWDM signal is then routed towards an optical output 340, having a connector for an optical fiber cable.

In the exemplary embodiment herein considered, the MDM card 210 is assumed to form the west line interface of the network node: the optical input 310 is thus connected to the line 110₁ (e.g., the optical fiber 110₁₁, in the case of the node 105₂) and the optical output 340 is connected to the line 110₂ (e.g., the optical fiber 110₂₁) of the network 100.

The other MDM card 215 forms the opposite, east line interface of the network node: the optical input 310 is in this case connected to the line 110₂ (e.g., the optical fiber 110₂₂), and the optical output 340 is connected to the line 110₁ (e.g., the optical fiber 110₁₂).

The MDM cards 210, 215 have a connector 345 suitable to engage the slots 205 of the shelf. The connector 345, in addition to provide mechanical connection of the card to the backplane, may be provided with electrical contacts for enabling electrical connection between the MDM cards 210, 215 and the electrical connection backplane 250 of the shelf, for example, in order to allow the SPV card detecting the presence of the MDM cards 210, 215.

Referring now to FIG. 4A, a TXT card base structure 400 according to an embodiment of the present invention is schematically shown, adapted to be used in the network node of FIG. 2. Essentially, the TXT card base structure 400 provides a multipurpose card infrastructure that can be variably equipped with different electro-optical and/or electronic components, and preferably configured so as to perform one or more of several different operations, such as the operations of signal regeneration (particularly, 3R regeneration), performance monitoring, add/drop of signals of CWDM channels, multiplexing of two or more low bit rate signals, particularly gray optical signals (e.g., coming from two different clients) into an aggregated optical signal to be injected into a single CWDM channel (and, viceversa, de-multiplexing a component optical signal of the CWDM signal for extracting low bit rate signals for different clients). In particular, the TXT card base structure 400 can be configured in such a way as to drop one or more of the component optical signals of the CWDM signal, to be provided to clients of the network (and, dually, to add optical signals, locally supplied by clients, to the CWDM signal).

The TXT card base structure 400 has a connector 440 suitable to engage the slots 205 of the shelf 200. The connector 440 includes electrical contacts for enabling electrical connection between the TXT card base structure 400 and the electrical connection backplane 250, necessary for supplying power to the TXT card base structure 400 and to the components equipping it (as will be described in the following), and for communicating with the SPV card.

The TXT card base structure 400 has sockets suitable for accommodating standardized electro-optical transceivers, in the shown example four sockets 405, 410, 415, 420. The transceivers, that can be plugged into the sockets 405, 410, 415, 420, are standardized transceivers, complying with a prescribed standard, such as, for example, Small Form Factor Pluggable (SFP) transceivers, or XFP transceivers (10 Gigabit SFP transceiver, an evolution of the SFP standard), both transceiver families complying to the prescriptions of the MultiSource Agreement (MSA) Group. More generally, the sockets 405, 410, 415, 420 have a uniform mechanical and electrical structure complying with a predefined scheme of mechanical and electrical coupling between the sockets of the TXT card base structure 400 and a class of transceivers to be accommodated in the respective sockets 405, 410, 415, 420.

A set of electro-optical transceivers is assumed to be available, each having a mechanical and electrical connection structure consistent with the predefined scheme of mechanical and electrical coupling of the sockets 405-420. In addition, in a preferred embodiment of the present invention, the transceivers are hot-pluggable, i.e., they can be inserted into/extracted from the respective socket even when the TXT card base structure 400 is powered, without the need of a preliminary powering down of the shelf.

With reference to FIG. 5, there is shown a functional scheme of an electro-optical transceiver 500, adapted to equip the TXT card by being plugged into one of the sockets 405-420; for example, but not limitatively, the transceiver 500 is an SFP transceiver.

The transceiver 500 has, on an optical side thereof, an optical input 505 and an optical output 510, accessible via respective (female) connectors adapted to receiving complementary (male) standard optical connectors; for example, the optical connectors are mounted at the ends of optical fiber cables, by means of which the optical input and output of the transceivers can be coupled to, e.g., one of the optical outputs/inputs 320₁-320₉/325₁-325₉ of the MDM card 210, 215. The transceiver 500 has, on an electrical side thereof, an electrical input 515 and an electrical output 520, accessible via a connector 535, matching a complementary electrical connector provided in every socket of the TXT card. For example, the SFP transceivers have a standard electrical connector that can be inserted into socket complying with such a standard.

In general terms, the transceiver 500 has two internal signal paths, a first path 505, 515 from the optical input 505 to the electrical output 515, and a second path 520, 510 from the electrical input 520 to the optical output 510. In the first path 505, 515 an optical signal, received at the optical input 505, is first converted into a corresponding electrical signal. The optical input 505 supplies the received optical signal, particularly one of the component optical signals of the CWDM signal, to a photodetector 525, that converts the component optical signal into a corresponding electrical signal. The electrical signal is then fed to an electronic circuitry 530, including a limited-amplifier 532 for adapting the electrical signal to a desired or specified voltage level standard (for example, in the case of SFP transceiver, the LVPECL standard). The adapted electrical signal is then routed to and made available at the electrical output 515.

In the second path 520, 510 an electrical signal received at the electrical input 520 is supplied to an optical source 540, particularly a laser; which converts the electrical signal into a corresponding optical signal, for example centered at the wavelength of one of the CWDM channels. The optical signal generated by the laser 540 is fed to and made available at the optical output 510.

The set of transceivers 500 may include transceivers designed to operate at each of the different wavelengths of the eight CWDM channels, and transceivers designed to operate at the wavelength of the OSC. In detail, considering a generic transceiver 500, the optical devices internal to the transceiver 500 (namely, the photodetector 525 and the optical source 540) can detect or emit at a respective operating wavelength, corresponding to the central wavelength of one of the CWDM channels (or corresponding to the wavelength of the OSC): this kind of transceiver is referred to as a colored transceiver. Furthermore, the set of transceivers may include transceivers in which the optical signals received at the optical input 505, and thus received by the photodetector 525, and transmitted from the optical output 510, generated from the optical source 540, are characterized by a wavelength different from the CWDM channel central wavelengths (and from the wavelength of the OSC channel): transceivers of this type, designed to operate on gray optical signals, are referred to as gray transceivers. The gray transceivers are, for example, used for communicating with clients.

Additionally, different transceivers for different range of communication bit rates of the received signal can be provided: the electronic circuitry 530 is capable to adapt the received electrical signal with communication bit rates in a prescribed range of bit rates, e.g., corresponding to the most common signal transmission standards.

Hot-pluggability of the transceiver 500 into a socket 405-420 of the TXT card is achieved, for example, thanks to a peculiar geometry of the contacts of the electrical connector 535. Typically, the transceiver 500 has electrical contacts for receiving a positive supply voltage V_{DD+}, a negative supply voltage V_{DD-} and a ground or reference voltage GND. These electrical contacts are designed to have a particular geometry, such that when the transceiver 500 is plugged into a generic one of the sockets 405-420, the ground voltage contact is established before the positive and negative supply voltage V_{DD+} and V_{DD-} contacts (as schematically shown in the enlarged detail in FIG. 5); when the transceiver 500 is unplugged from one of the sockets 405-420, the ground voltage contact is the last to be interrupted. In this way, the transceiver 500 can be plugged into, and unplugged from, the sockets also when the TXT card is powered, i.e. inserted into a slot of the shelf, without the risk of causing dangerous voltage glitches on the transceiver and/or the TXT card circuits.

Referring back to FIG. 4A, once the TXT card base structure 400 is equipped with the prescribed number and type of transceivers, a TXT card is obtained that can receive and transmit optical signals through optical fiber cables 422ᵢ and 422ₒ connected to the optical inputs and outputs of the transceivers that are plugged into its sockets 405-420.

The TXT card base structure 400 also includes an electronic switch device 425, for properly routing the electrical signals received from the sockets 405-420 in the desired way, and, coupled to the switch device 425, an electronic circuitry 428, in particular a circuitry adapted to performing the 3R signal regeneration, the performance monitoring and the function of multiplexer/de-multiplexer of electrical signals. The switch device 425 is adapted to route signals received from any one of the sockets 405-420 to any one of the sockets 405-420 (included the socket from which the signals are received) and to the electronic circuitry 428, and from the electronic circuitry 428 to any one of the sockets 405-420.

Considering FIG. 4B, a functional block scheme of the electronic circuitry 428, according to an embodiment of the present invention, is shown. The electronic circuitry 428 equips the TXT card and receives the electrical signals, converted from the optical domain by the transceivers plugged into the sockets, from the switch device 425 through electrical connections 429ᵢ.

The electronic circuitry 428 includes four Clock Data Recovery (CDR) circuits 432, particularly universal CDRs, for carrying out the operation of 3R regeneration of the electrical signals; each of the CDR 432 substantially includes an integrated frequency synthesizer, typically a PLL, which is able to adapt itself to bit rates comprised into a broad range, and which is connected to a respective additional circuitry 433 for monitoring the performance of the received signal.

The additional circuitries 433 in the electronic circuitry 428 are adapted to monitoring the performances of the communications network. In particular, the additional circuitries 433 (hereinafter, referred to as performance monitors) detect the presence/absence of the signal and are adapted to measure the BER and to scan the data eye of the incoming signals. The performance monitors 433 supply information on the received signals to the outside of the electronic circuitry 428 through a bus 431. Commercially available electronic devices adapted to perform 2R and/or 3R regeneration may be also capable of executing the performance monitoring on the electrical signals derived by conversion from the optical signals.

The regenerated electrical signals are then provided by the performance monitors 433 to a circuitry 430, capable of performing the multiplexing/de-multiplexing of electrical signals. If the multiplexing/de-multiplexing operations are not required, the regenerated electrical signals are not processed by the circuitry 430 and are instead directly provided by the circuitry 430 to the outside of the electronic circuitry 428 through electrical connections 429₀. The FPGA 430 needs to be properly configured and, to this end, receives external instructions by a further bus 434.

Alternatively, the 3R regeneration and the performance monitoring of each of the incoming signals can be executed by a single device (such as the VSC8123 chip produced by Vitesse), or the 3R regeneration of all the incoming signals can be executed by a single device (such as the CX20501 chip produced by Mindspeed) connected to four performance monitors (such as the VSC8150 chip produced by Vitesse). Furthermore, each CDR 432, cascade-connected to the respective performance monitor 433, can be placed between the sockets 405-420 and the switch device 425 and the electronic circuitry 428 can implement only the. multiplexing/de-multiplexing of electrical signals provided by the switch device 425.

In an embodiment of the present invention, the electronic circuitry 428 is implemented by means of one or more hardware-programmable devices, such as FPGAs, that can be properly configured so as to implement the desired functions. In this way, it can be appreciated that the switch device 425 may be implemented by an FPGA device, as well.

Referring back to FIG. 4A, the TXT card base structure 400 is further equipped by a microprocessor/microcontroller 435 for controlling and properly configuring the switch device 425 (so as to implement any one of a set of prescribed routings of the electrical signals to/from the sockets) and the electronic circuitry 428, particularly the circuitry 430 (so as to execute the desired multiplexing/de-multiplexing of electrical signals), by means of configuration instructions.

The TXT card base structure 400 further includes electrical connections between the sockets 405-420 and the microprocessor/microcontroller 435, for enabling the communication between the microprocessor/microcontroller 435 and the transceiver or transceivers, when the latter are plugged into the sockets. To this purpose, it is observed that the electronic circuitry 530 of the transceivers 500 is preferably such that, when the transceiver is plugged into one of the sockets 405-420, the microprocessor/microcontroller 435 can acknowledge the presence of the transceiver and, possibly, recognize the type of transceiver by reading transceiver characteristic parameters (such as the operating wavelengths supported by the optical devices and the range of bit rates supported by the electronic circuitry 530). The microprocessor/microcontroller 435 can, for example, exploit these data to properly configure the switch device 425 and/or the FPGA 430.

Furthermore, the microprocessor/microcontroller 435 can collect information on the signals processed by the electronic circuitry 428 (such as BER estimation and presence/absence of the signal), obtained from the performance monitoring operated by the performance monitors 433. The microprocessor/microcontroller 435 processes the information and communicates with the SPV card 235 through a bus of the electrical connection backplane of the shelf. In turn, the SPV card 235 can send specific commands to the microprocessor/microcontroller 435, for example in response to the processed information; by way of example, the SPV card 235 can send to the microprocessor/microcontroller 435 instructions for configuring the switch device 425 in a different way, for example for protection purposes.

The TXT card base structure 400 can be hardware and software configured: the structure is hardware configurable by plugging different types and a different number of transceivers 500 into the four sockets 405-420; additionally, the TXT card base structure 400 is software configurable, by the microprocessor/microcontroller 435, which controls the operations on the TXT card base structure 400. In this way, the TXT card base structure 400 is suitable to realize a variety of different TXT cards, which can perform several different functions.

In the following, an exemplary and non-exhaustive list of possible TXT card configurations is provided.

For example, let it be assumed that the TXT card base structure 400 is equipped with one colored transceiver 500, operating at a generic central wavelength λₓ, and one gray transceiver for gray signals, plugged into two of the sockets 405-420, to implement a bi-directional adaptation of optical signals of one CWDM channel for communicating with a client at a wavelength different from the CWDM central channel wavelengths. For ease of reference, a TXT card base structure 400 configured in this way will be hereinafter referred to as TXT-A card.

The component optical signal at wavelength λₓ, which is a component signal of the CWDM signal received from one of the lines 110₁, 110₂, is received from a first one 210 of the two MDM cards 210, 215, and is supplied to the TXT-A card through a section 422ᵢ of optical fiber cable, terminated by suitable connectors (this optical fiber cable section is called in jargon optical fiber riser); the riser 422ᵢ is connected to a corresponding optical output 320₁-320₉ of the first MDM card 210, and to the corresponding optical input of the colored transceiver 500 plugged into one of the sockets 405-420.

The colored transceiver 500 converts the colored optical signal at wavelength λₓ into a corresponding electrical signal, which is then adapted by the limited-amplifier of the colored transceiver 500. The electrical signal, made available at the electrical output 515 of the colored transceiver 500, is routed to the switch device 425, assumed to have been properly configured by the microprocessor/microcontroller 435. The switch device 425 routes the received electrical signal, corresponding to the colored optical signal at wavelength λₓ, toward the electronic circuitry 428, which actuates the 3R regeneration of the electrical signal, monitoring at the same time the performance of the communications network as far as those colored signals are concerned.

In particular, supposing that the TXT-A card is connected to the MDM card 210 by the optical fiber riser 422ᵢ connected to the colored transceiver plugged into the socket 405, the switch device 425 can be configured so as to route the regenerated electrical signal, received from the electronic circuitry 428, towards the gray transceiver 500 plugged into the socket 415. The gray transceiver in the socket 415 converts the regenerated electrical signal into a gray optical signal, and the gray optical signal is made available at the optical output 510 of the gray transceiver 500, where the gray optical signal can be taken up by the client through an optical fiber cable 422ₒ.

It is observed that a gray optical signal, locally supplied by a client connected to the network node, could as well be injected into the gray transceiver 500, plugged into the socket 415, by means of optical fiber cable 422ᵢ. Then, the gray optical signal is processed by the TXT-A card in a way equivalent to the above-described one. The gray optical signal is converted into an electrical signal by the gray transceiver, regenerated by the electronic circuitry 428, routed by the switch device 425 to the colored transceiver in the sockets 405 and, finally, converted into a colored optical signal at the wavelength λₓ. In this way, the colored optical signal at the wavelength λₓ is made available at the optical output 510 of the colored transceiver 500. The colored signal can be taken up by optical fiber riser 422ₒ, connected to the optical output of the colored transceiver, which allows feeding the colored optical signal at wavelength λₓ to the MDM card 210, so as to be injected into the line 110₂ of the communication network.

It is observed that, in order to actuate the protection mechanism in a node of the 2F ring network 100, the TXT-A card has to be modified by plugging into one of the available sockets a redundant colored transceiver, operating at the same CWDM channel central wavelength λₓ as the first colored transceiver; the resulting card is referred to as TXT-G card. The redundant colored transceiver is connected to the second MDM card 215 through optical fiber risers 422ₒ, 422ᵢ, respectively, for re-injecting the colored optical signal at wavelength λₓ into the line 110₁ and for redundantly receiving the colored optical signal at wavelength λₓ from the line 110₂.

The switch device 425 is capable of routing in any desired way each one of the electrical signals obtained by conversion from the component optical signals of the CWDM signal. Consequently, it is possible to route the electrical signals, corresponding to the received optical signals, towards the desired socket, or to switch off the electrical signals corresponding to the redundant optical signals just by properly configuring the switch device 425, without the necessity of having different TXT cards base structures equipped with different switch devices 425.

In a further possible configuration, two colored transceivers and two gray transceivers are plugged into the sockets 405-420 of the TXT card base structure 400. A TXT card base structure 400 configured in this way, hereinafter referred to as TXT-D card, permits to connect two clients to the network node. When two of the optical signals composing the CWDM signal have to be dropped and provided to the two clients, the colored transceivers operate at the respective CWDM component wavelength, and the switch device 425 properly routes towards each socket 405-420 the desired signal. When configured in this way, the TXT card not only allows adding/dropping signals transported by two CWDM channels, but additionally implements a bi-directional adaptation of the optical signal wavelength.

As further example of configuration of the TXT card base structure 400 (referred to as TXT-F card), one colored transceiver 500 is plugged into one, of the sockets, e.g. the socket 405 and receives from one of the lines 110₁, 110₂ (i.e., from the MDM card 210 or 215) a colored optical signal at a CWDM channel central wavelength λₓ, while two gray transceivers 500 are inserted into two of the remaining sockets, for example the sockets 415 and 420. The colored transceiver converts the colored optical signal at the wavelength λₓ into a corresponding electrical signal, which is fed to the switch device 425. The switch device 425, in the TXT-F card configuration, routes the electrical signal towards the electronic circuitry 428, which applies the 3R regeneration to the electrical signal, de-multiplexes the regenerated electrical signal into two electrical signals at a lower bit rate, and supplies the de-multiplexed lower bit rate signals back to the switch device 425. In this way, the switch device 425 can provide each of the two lower bit rate signals to a respective one of the two gray transceivers housed in the sockets 415, 420. The gray transceivers convert the respective lower bit rate electrical signal into a gray optical signal, which, through optical fiber riser cables 422ₒ connected to the gray transceivers, can be fed to the respective client. The same TXT-F card is also capable of carrying out the opposite process on two gray optical signals with low bit rate, received from two clients; the two gray optical signals can be multiplexed over a single colored optical signal, with higher bit rate, at one of the CWDM channel central wavelengths, fed to one of the MDM cards for being multiplexed with the other component signals of the CWDM signal.

The TXT-F card may be expanded by plugging into the remaining socket 410 a further, redundant colored transceiver, operating at the same wavelength λₓ as the first colored transceiver, for actuating the protection mechanism on the corresponding CWDM channel. Each of the colored transceivers is connected to the MDM cards, through the optical fiber cable risers 422ᵢ, 422ₒ. This configuration is referred to as TXT-H configuration of the TXT card base structure 400.

In a simpler configuration, the TXT card base structure 400 can be configured by using two colored transceivers 500, one in one socket, e.g. the socket 405, or, alternatively, in the socket 410, and another one in another socket, for example the socket 415 or 420. For ease of reference, a TXT card base structure 400 configured in this way will be hereinafter referred to as TXT-B card. Typically, the TXT-B card is used for line-to-line operation in a network node, because it permits to execute the 3R bi-directional regeneration (and the performance monitoring) of one colored signal composing the CWDM signal, and the actuation of the protection mechanism on this CWDM channel.

As a further example of TXT card used for line-to-line operations in a network node (hereinafter referred to as TXT-E card), the TXT card base structure 400 can be equipped with four colored transceivers 500, two of which plugged into two of the sockets, e.g. the sockets 405, 420 and operating at a wavelength λₓ, and two plugged into the remaining two sockets 410, 415 and operating at a wavelength λ_{y}, where λₓ and λ_{y} are two CWDM channel central wavelengths. Similarly to the TXT-B card, the TXT-E card permits the execution of the 3R bi-directional regeneration (and performance monitoring) of two colored signals composing the CWDM signal and the actuation of the protection mechanism on two CWDM channels.

It is observed that the electrical signals generated by conversion of the optical signals can be looped back, i.e., the switch device 425 can receive a signal from a colored transceiver housed in one of the sockets 405-420 and route the same signal back to the same transceiver. In detail, in a configuration referred to as loop-back configuration, the switch device 425 can provide the electrical signals, converted by the transceivers and corresponding to the respective component optical signal of the CWDM signal, to the electronic circuitry 428, the electronic circuitry 428 actuates the 3R regeneration (and the performance monitoring) on the electrical signals and the switch device 425 routes the regenerated electrical signals back to the corresponding transceiver. In this way, the TXT card only performs the 3R regeneration (and the performance monitoring) of the received signals on a number of CWDM channels varying from one to four, depending on the number of colored transceivers inserted in the sockets. Alternatively, in a simple transparent pass-through configuration the switch device 425 can directly route the electrical signals back, converted by the transceivers, to the same transceivers, without routing the electrical signals to electronic circuitry 428, which executes the 3R regeneration.

As a simple example, by inserting one colored transceiver into one of the sockets 405-420 and exploiting the loop-back configuration of the switch device 425 (TXT-C card configuration of the TXT card base structure 400), 3R uni-directional regeneration of the signal of one CWDM channel can be implemented; this is, for example, useful in a pass-through node in a 1F ring network.

Considering now FIG. 6A, an exemplary schematic block diagram of a node 105ᵢ of the network 100, according to an embodiment of the present invention, is shown (the elements corresponding to those in FIGS. 1, 2 and 3 are denoted with the same reference numerals, and their description is omitted for the sake of simplicity). The node 105ᵢ includes one shelf 200, housing in particular two MDM cards 210, 215, one TXT-B card 602 and one TXT-G card 603. The TXT-B card 602 has a west-side optical input 655 and a west-side optical output 675, an east-side optical input 665 and an east-side optical output 670, corresponding to the optical inputs and outputs of the two colored transceivers that are plugged into the sockets of the TXT card base structure. The TXT-G card 603 has two optical inputs 610, 620 and two optical outputs 645, 650 for colored optical signals (corresponding to the optical inputs and outputs of the two colored transceivers plugged into the respective sockets); the TXT-G card 603 further has one optical input 640 and one client optical output 630 for gray optical signals (corresponding to the optical input and output of the gray transceiver).

The node 105ᵢ is supposed to be connected to a client 605 and receives the traffic of the communications network from the line 110₁ at the west bi-directional line interface, and from the line 110₂ at the east bi-directional line interface; the node 105ᵢ re-transmits the traffic into the line 110₁ at the east line interface and into the line 110₂ at the west line interface. The MDM card 210 is located at the west line interface and the lines 110₁, 110₂ are connected to its optical input and output, respectively. The MDM card 215 is located at the east line interface, and the lines 110₁, 110₂ are respectively connected to the optical output and input thereof.

The MDM card 210 de-multiplexes the CWDM signal, received from the line 110₁, into the component signals (one for each CWDM channel); one of the de-multiplexed signals, associated with the CWDM channel central wavelength λₓ, is routed (through an optical fiber riser) to the optical input 610 of the TXT-G card 603, located at the client interface of the node 105ᵢ, for add/drop operations. Concurrently, the MDM card 215 de-multiplexes the CWDM signal, received from the line 110₂, and the component signal centered at the wavelength λₓ is redundantly routed to the optical input 620 of the TXT-G card 603, for protection purposes. As long as no failures take place along the working communication path, the switch device 425, internal to the TXT-G card 603, routes to the gray transceiver present on the card 603 only the electrical signal corresponding to the colored optical signal received at the optical input 610 from the MDM card 210.

The client 605 receives a gray signal corresponding to the signal centered at the wavelength λₓ through a secondary optical fiber cable 625, connected between an optical input 693 of the client 605 and the optical gray output 630 of the TXT-G card 603 at the client interface; the client 605 re-transmits the gray signal through a further secondary optical fiber cable 635, connected between an optical output 695 of the client 605 and the gray optical input 640 of the TXT-G card 603 at the client interface. The switch device of the TXT-G card 603 is configured for routing the signal received from the client 605 to both the optical outputs 645 and 650, and thus to both the MDM card 210 and to the MDM card 215, for protection purposes. The MDM cards 210 and 215 receive the optical signal centered at the wavelength λₓ from the optical outputs 645 and 650 of the TXT-G card 603, respectively, and multiplex it with the other component signal of the CWDM signal.

The MDM card 210 transmits the component optical signal at the wavelength λ_{y} (y=1, . . . , 8, y differing from x) to the west side optical input 655 of the TXT-B card 602 only for 3R regeneration and performance monitoring purposes. The TXT-B card 602 transmits the regenerated optical signal at the wavelength λ_{y} to the MDM card 215 from the east side optical output 665. Viceversa, the MDM card 215 transmits the signal at the wavelength λ_{y} to the optical input 670 (east side) of the TXT-B card 602, which transmits the signal at the wavelength λ_{y} to the MDM card 210 from the west side optical output 675.

The component signals of the CWDM signal received from the line 110₁ and different from those at the wavelengths λₓ, λ_{y} are de-multiplexed by the MDM card 210 and are directly supplied to the MDM 215 card, which multiplexes these signal into the CWDM signal together with the signals centered at the wavelengths λₓ, λ_{y}, provided by the TXT-G card 603 and the TXT-B card 602, respectively. The CWDM signal is re-injected in the line 110₁, which is connected to the optical output of the MDM card 215 at the east line interface of the node 105ᵢ. Similarly, the component signals received from the line 110₂ and different from those at the wavelengths _{λ}ₓ, λ_{y}, are de-multiplexed by the MDM card 215 and are supplied directly to the MDM 210 card, which permits to re-inject the traffic in the line 110₂, connected to the optical output of the MDM card 210 at the west line interface of the node 105ᵢ.

The configuration of the node 105ᵢ can be enriched by providing a plurality of TXT cards, for regenerating the other component signals of the CWDM signal (in particular, three TXT-E cards can be provided, each one capable to process signals of two CWDM channels).

The TXT-G card 603 also executes the 3R regeneration and the performance monitoring on the received signal. The performance monitoring allows the TXT-G card 603 acquiring significant parameters on the received signal; these parameters are, for example, used for implementing the protection mechanism. If the TXT-B card 602 detects a failure in the received signal, the information is returned to the SPV card of the shelf 200 (not shown in the drawing) by a bus of the electrical connection backplane of the shelf. The SPV card communicates over the OSC channel with all the nodes of the network, so as to indicate that the working communication path incurred in a failure and the protection communication path of the network needs to be exploited.

If the signal received from the MDM card 210 is, for example, absent or with a bad estimated BER, the protection mechanism permits to re-configure the switch device 425, internal to the TXT-G card 603. In the new configuration, the switch device routes the signal received at the optical input 620 from the MDM card 215 to the client 605. Otherwise, in case the TXT-G card 603 detects a failure in the signal received from the client 605, the switch device can be configured to implement the loop-back of the signal received from the MDM card 210 at the optical input 610, which is in this case directly routed to the optical output 650 of the TXT-G card 603, while the signal received from the MDM card 215 at the optical input 620 is directly routed to the optical output 645. The client 605 is thus isolated until the failure is overcome.

The above-described protection mechanism is called 1+1 Optical Channel Protection mechanism, and exploits, for implementing client interfaces, TXT cards equipped with a redundant colored transceiver for receiving the corresponding signal from both the east and the west line interfaces.

Referring to FIG. 6B, an exemplary schematic block diagram of a node 105ᵢ of the network according to an alternative embodiment of the present invention is shown (the elements corresponding to those in FIGS. 1, 2, 3 and 6A are denoted with the same reference numerals, and their description is omitted for the sake of simplicity).

In the node 105ᵢ of this embodiment, in place of the TXT-G card, two TXT-A cards 675, 680 are used, inserted in two corresponding slots of the self 200. The TXT-A cards 675 and 680 have optical inputs 676, 681 and optical outputs 677, 682 for colored optical signals, corresponding to the operating wavelengths of the colored transceiver plugged in two of the four sockets 405-420, and optical inputs 678, 683 and optical outputs 679, 684 for gray signals, corresponding to the operating wavelengths of the gray transceivers inserted in the remaining two sockets.

In this alternative configuration, the client 605 is connected to the node 105ᵢ by means of two optical fiber Y-cables 685 and 690, i.e., optical fiber cables having three branches 685ₐ, 685_{b}, 685_{c} and 690ₐ, 690_{b}, 690_{c}, respectively, adapted to split an incoming optical signal into two, half-power output optical signals. In detail, the branches 685ₐ, 690ₐ of the two Y-cables 685, 690 are respectively connected to the optical input 693 and output 695 of the client 605, the branches 685_{b}, 690_{b} are connected to the optical inputs 678, 683 of the TXT-A card 675, 680, the branches 685_{c}, 690_{c} are connected to the optical outputs 679, 684 of the TXT-A card 675, 680.

The TXT-A card 675 receives at the optical input 676 thereof the component optical signal at the wavelength λₓ, and the TXT-A card 680 redundantly receives the same optical signal at the optical input 681. The TXT-A cards 675 and 680 process the received signals for executing 3R regeneration and performance monitoring, and the processed signals are made available at the optical output 679, 684, respectively. In order to avoid optical collision between the two processed optical signals, the optical signal transmitted by the TXT-A card 680 is switched off, thanks to a proper configuration of the switch device 425 of the TXT-A card 680.

In turn, the client 605 re-transmits the respective signal through the Y-cable 690 to both the TXT-A card 675 and the TXT-A card 680, for protection purpose. The two signals at the wavelength λₓ, processed by the TXT-A cards 675 and 680, are provided to the colored optical outputs 677, 682, respectively, for being multiplexed into the CWDM signal by the MDM card 210, 215 with the signals centered at the other CWDM component wavelengths.

If the signal received from the MDM card 210 is, for example, absent or with a bad estimated BER, the protection mechanism permits to re-configure the switch devices 425, internal to the TXT-A cards 675 and 680. In particular, the switch device of the TXT-A card 680 is re-configured to route the gray optical signal from the optical output 684 to the client 605, and the switch device of the TXT-A card 675 switches off the gray optical signal that can be provided to the optical output 679. Otherwise, in case the TXT-A cards 675 and 680 detect a failure in the signal received from the client 605, the switch devices are re-configured to implement the loop-back configuration, i.e., the signal received from the MDM card 210 at the optical input 676 is directly routed to the optical output 677 of the TXT-A cards 675, while the signal received from the MDM card 215 at the optical input 681 is directly routed to the optical output 677. The client 605 is thus isolated until the failure is overcome.

The above-described protection mechanism can be defined a 1+1 Equipment Protection mechanism, which exploits two redundant TXT cards for implementing client interfaces, each one receiving and transmitting the same signal.

With reference now to FIG. 7, a schematic illustration of an additional card 700 (in the following, MTX card), according to an embodiment of the present invention, adapted to be used in the network node of FIG. 2, is shown. Similarly to the TXT card, the MTX card 700 provides an infrastructure that can be variably equipped with components and configured so as to perform transparent multiplexing/de-multiplexing of two or more low bit rate signals, provided by clients of the network, (for example, signals complying to the ESCON communication protocol) into/from a higher bit rate aggregated signal (e.g., a signal with a Fiber Channel bit rate).

The MTX card 700 of the shown embodiment has four sockets 705, 710, 715, 720, corresponding to client interfaces, and a socket 725, corresponding to the line interface, that, similarly to the sockets 405-420 of the TXT card, can receive standard electro-optical transceivers, particularly transceivers complying to the same standard as the transceivers 500 used for configuring the TXT card.

The MTX card 700 is equipped by a microprocessor/microcontroller 735, as the TXT card, and by an electronic circuitry 728, similar to the one that equips the TXT card; particularly, the FPGA of the electronic circuitry 728 can multiplex four low bit rate signals into one aggregated, high bit rate signal.

The MTX card 700 has electrical connections between the sockets 705-725 and the electronic circuitry 728 for the exchange of signals between the transceivers. In particular, the microprocessor/microcontroller 735 collects information on the signals received by the MXT card 700 (such as BER estimation and presence/absence of the signal), obtained from the electronic circuitry 728. The MTX card 700 further has electrical connections between the sockets 705-725 and the microprocessor/microcontroller 735 for enabling the communication between the microprocessor/microcontroller 735 and the transceivers plugged into the sockets 705-725. The processed information is supplied to the SPV card by a bus of the electrical connection backplane of the shelf. The commands provided by the SPV card enables the microprocessor/microcontroller 735 to control and properly configure the FPGA of the electronic circuitry 728.

The MXT card 700 has a connector 740 suitable for engaging the slots 205 of the shelf 200 of the network node, and with electrical contacts for enabling connections between the MXT card 700 and the electrical connection backplane, as the TXT cards.

The socket 725 is intended to receive a colored transceiver 500 adapted to process one of the component signals of the CWDM signal, received from the MDM card 210 or 215 through an optical fiber riser 745₁. The high bit rate electrical signal resulting from the optical-electrical conversion is supplied to the electronic circuitry 728, which de-multiplexes it into four low bit rate electrical signals. Each low bit rate electrical signal is then routed to a corresponding transceiver in one of the sockets 705-720, which re-converts the received electrical signal into a gray optical signal to be dropped by the respective client through the optical fiber cable 745_{c}.

The opposite process (add process) is possible: the low bit rate signals coming from the clients through the optical fiber cables 745_{c} connected to the MTX card 700 are multiplexed by the electronic circuitry 728 into a higher bit rate aggregated signal. The higher bit rate aggregated signal, re-converted into a colored optical signal by the transceiver 500 in the socket 725, is then provided to the MDM card 210 or 215, by the optical fiber riser 745₁, to be re-injected into the traffic of the network.

Two MTX cards 700 can be inserted in a shelf of a network node and connected to a TXT-H card by optical fiber risers for further multiplexing the two respective aggregated signals. In detail, the two aggregated signals, provided by the two MTX cards 700 to the TXT-H card, can be two Fiber Channel signals (i.e., signals with a bit rate of about 1.25 Gb/s), which can be multiplexed into an aggregated signal with a higher bit rate of about 2.7 Gb/s (such as a Gigabit Ethernet bit rate), then converted into a component optical signal of the CWDM signal. Alternatively, instead of using gray transceivers 500 in the sockets 725 and in the sockets 415, 420 of the TXT-H card, electrical adapters (such as the copper HSSDC2 transceivers produced by Molex) can be plugged into the respective socket. In this way, the MTX cards 700, after the multiplexing operation, does not need to re-convert the electrical signals into optical signals and the TXT-H card can directly process the received electrical signals. In this case, the two MTX cards 700 can be connected to the TXT-H card by wires, e.g. copper patch cables.

It can be appreciated that the present invention provides a network node structure having multiple levels of configurability; particularly, two levels of configurability are provided: a first level of configurability is ensured by the provision of card base structures, such as the TXT card base structure 400, that can be variably equipped with components and configured so as to perform different functions; a second level of configurability derives from the possibility of exploiting different numbers and types of cards, depending on the needs.

Thanks to this structure, the flexibility of the node 105ᵢ of the network is significantly increased.

In particular, hot-pluggability of the transceivers into the sockets of the TXT and MTX cards allows configuring the node 105ᵢ in an easy way, without interruptions of the communications network services.

Naturally, in order to satisfy local and specific requirements, a person skilled in the art may apply to the solution described above many modifications and alterations all of which, however, are included within the scope of protection of the invention as defined by the following claims.

1-21. (canceled)

22. A network node structure for an optical communications network, comprising:
a housing having a plurality of slots; and
a plurality of cards inserted in the slots, said plurality of cards comprising:
at least one first card having an optical input for receiving an input WDM optical signal from an optical line of the network, a first optical device for extracting at least one component optical signal at a wavelength from the input WDM optical signal and at least one optical output making available the at least one component optical signal;
at least one second card, separate from the first card, having at least one socket mechanically and electrically adapted to receive one of a plurality of interchangeable electro-optical components, each component having an optical input adapted to receive an input optical signal at a prescribed operating wavelength, an optical-to-electrical conversion unit for converting the received optical signal into a corresponding converted electrical signal, an electrical output making available the converted electrical signal, and an electrical input adapted to receive an input electrical signal, an electrical-to-optical conversion unit for converting the received electrical signal into a corresponding optical signal at the prescribed operating wavelength, an optical output making available the converted optical signal, a selected electro-optical component of said plurality of components being plugged into the socket and having an operating wavelength corresponding to the wavelength of the extracted component optical signal, an electronic circuitry in bi-directional communication relationship with said at least one socket for treating the converted electrical signal provided by said selected electro-optical component; and
at least one first optical waveguide connected between the at least one optical output of the first card and the optical input of the selected electro-optical component, for feeding to the optical input of the selected electro-optical component the extracted component optical signal.

23. The network node structure according to claim 22, further comprising, on one of said plurality of cards, a second optical device having at least two optical inputs, each one adapted to receive a respective input optical signal comprising at least one component optical signal of an output WDM optical signal made available at an optical output of the second optical device to the optical line of the network, the second optical device combining the input optical signals into the output WDM optical signal, and
at least one second optical waveguide connected between one of the at least two optical inputs of the second optical device and the optical output of the selected electro-optical component, for delivering to the second optical device the component optical signal generated by the electro-optical conversion of the input electrical signal operated by the selected electro-optical component.

24. The network node structure according to claim 23, wherein the input electrical signal is the converted electrical signal treated by the electronic circuitry.

25. The network node structure according to claim 23, wherein the input electrical signal corresponds to a client signal of a local client of the network node.

26. The network node structure according to claim 23, wherein:
the first optical device comprises an optical de-multiplexer for de-multiplexing the input WDM optical signal into a plurality of component optical signals, the at least one optical output of the first card comprising a plurality of optical outputs each one making available one of the plurality of component optical signals; and
the second optical device comprises a multiplexer for multiplexing the component optical signals into the output WDM optical signal, the at least two optical inputs of the second optical device comprising a plurality of optical inputs, each one being adapted to receive a respective component optical signal.

27. The network node structure according to claim 23, wherein said second optical device is provided on the first card.

28. The network node structure according to claim 23, wherein said second optical device is provided on a third card distinct from the first and second cards.

29. The network node structure according to claim 23, wherein said optical line of the network comprises a first optical line coupled to the optical input of the first card and a second optical line coupled to the optical output of the second optical device.

30. The network node structure according to claim 22, wherein said electronic circuitry comprises circuits adapted to regenerate the converted electrical signal.

31. The network node structure according to claim 30, wherein said circuits are adapted to perform at least 2R signal regeneration, or 3R signal regeneration.

32. The network node structure according to claim 22, wherein the interchangeable electro-optical components are hot pluggable/unpluggable into/from the at least one socket of the second card.

33. The network node structure according to claim 32, wherein said interchangeable electro-optical components are electro-optical transceivers complying with the MultiSource Agreement, Small Form Factor Pluggable or 10 Gigabit Small Form Factor Pluggable transceivers.

34. The network node structure according to claim 22, wherein said second card has at least a second socket, a selected second electro-optical component of said plurality of components being plugged into the second socket and receiving/transmitting electrical signals from/to the selected electro-optical component plugged in the first socket, an optical link being further provided between the second electro-optical component and a client of the network node.

35. The network node structure according to claim 34, wherein said second electro-optical component has an operating optical wavelength corresponding to that of a selected one of the component optical signals.

36. The network node structure according to claim 34, wherein said second electro-optical component has an operating optical wavelength different from those of the component optical signals.

37. The network node structure according to claim 22, wherein said at least one second card further comprises a configurable electronic switch for routing the converted electrical signal received from the at least one socket toward the electronic circuitry and for routing the converted electrical signal treated by the electronic circuitry toward the at least one socket.

38. The network node structure according to claim 37, wherein said at least one second card also comprises a control unit controlling the configurable electronic switch.

39. The network node structure according to claim 38, wherein the second card comprises an electrical connection arrangement between the control unit and the socket, and in which the control unit is capable of detecting the presence of an electro-optical component in the socket and to automatically configure the electronic switch according to one of a number of predetermined switch configuration patterns.

40. The network node structure according to claim 38, wherein the electronic circuitry is capable of monitoring characteristic parameters of the converted electrical signal so as to assess a level of communication performances, said characteristic parameters being communicated to the control unit.

41. The network node structure according to claim 22, wherein the electronic circuitry of the at least one second card further comprises an electrical multiplexing/de-multiplexing electronic component, adapted to receive two or more converted electrical signals at a first bit rate, coming from corresponding sockets, to multiplex the two or more converted electrical signals into an aggregated electrical signal at a second bit rate higher than the first bit rate, to be provided to a corresponding socket, and, dually, adapted to receive an electrical signal at the second bit rate and to de-multiplex it into two or more electrical signals at the first bit rate.

42. An optical communications network comprising at least one network node having a structure according to any one of claims 22-41.
